(19) United States
(12) Patent Application Publication
(10) Pub. No.: US 2026/0077285 A1
(43) Pub. Date: Mar. 19, 2026

(54) AIR FILTER MEDIUM, FILTER PLEAT PACK, AND AIR FILTER UNIT

(71) Applicant: NITTO DENKO CORPORATION, Osaka (JP)

(72) Inventors: Go SATO, Osaka (JP); Noriaki HARADA, Osaka (JP); Shunsuke MASAKI, Osaka (JP)

(73) Assignee: NITTO DENKO CORPORATION, Osaka (JP)

(21) Appl. No.: 19/127,440

(22) PCT Filed: Nov. 10, 2023
(86) PCT No.: PCT/JP2023/040654

§ 371 Date: May 6, 2025

(30) Foreign Application Priority Data
Nov. 22, 2022 (JP) 2022-186849

(51) Int. Cl. B01D 39/16; B01D 39/20; B01D 46/52

(52) U.S. Cl. CPC B01D 39/1623; B01D 39/1669; B01D 39/2003; B01D 46/521

(57) ABSTRACT

An air filter medium including a porous fluorine resin membrane, the air filter medium further including a glass filter medium layer, wherein the glass filter medium layer and the porous fluorine resin membrane are placed in this order from upstream to downstream of the air filter medium configured to allow airflow to pass through the air filter medium. The porous fluorine resin membrane includes a plurality of nodes and a plurality of fibrils, and in an area distribution of the nodes, when an area of the node corresponding to a cumulative relative frequency of 95% from a smaller area is defined as S95, the porous fluorine resin membrane satisfies 2.0 μm²≤S95≤8.0 μm².

### TECHNICAL FIELD

The present invention relates to an air filter medium including a porous fluorine resin membrane, a filter pleat pack including the filter medium, and an air filter unit including the filter medium.

### BACKGROUND ART

Porous fluorine resin membranes, which have countless fine pores, exhibit excellent collection performance for particles such as dust and are accordingly used in various types of air filter media. Porous fluorine resin membranes generally function as surface filtration media that collect collection objects that are objects to be collected at their surface portions. Accordingly, when an air filter medium including a porous fluorine resin membrane is used for collecting particles contained in the atmosphere, for example, in an outside air treatment filter or a turbine air-intake filter, the air filter medium tends to cause an increase in pressure drop due to clogging. In consideration of this, a prefilter is conventionally placed on the upstream side in a direction of airflow that passes through a porous fluorine resin membrane. By having the prefilter collect some amount of a collection object having a relatively large particle size, clogging of the porous fluorine resin membrane located on the downstream side in the airflow direction can be suppressed, extending the service life of the air filter medium. Patent Literature 1 discloses an exemplary air filter medium including a porous polytetrafluoroethylene (hereinafter referred to as “PTFE”) membrane, which is a type of porous fluorine resin membrane, and a prefilter.

### CITATION LIST

### Patent Literature

Patent Literature 1: JP 2013-63424 A

### SUMMARY OF INVENTION

### Technical Problem

The present inventors have found that particles such as dust contained in the atmosphere include not only coarse particles having a particle size of 1 to 50 μm but also many fine particles having a particle size of approximately 0.1 μm. Studies conducted by the present inventors have revealed that, in an environment containing such fine particles in the atmosphere, even using an air filter medium including a prefilter causes an increase in pressure drop due to clogging of the porous fluorine resin membrane. Patent Literature 1 takes no account of this point.

The present invention aims to provide an air filter medium including a porous fluorine resin membrane and suitable, even in an environment containing fine particles having a particle size of approximately 0.1 μm, for suppressing an increase in pressure drop while suppressing a reduction in collection efficiency.

### Solution to Problem

The present inventors, as a result of extensive studies, have found that the above aim can be achieved by adjusting the node size in a porous fluorine resin membrane. The general view has conventionally been that particles such as dust contained in the atmosphere are collected by countless fluorine resin fibrils, which are fine fibrous structures forming the porous fluorine resin membrane. However, according to studies conducted by the present inventors, fine particles having a particle size of approximately 0.1 μm and contained in the atmosphere adhere not only to fibrils but also to fluorine resin nodes connected to the fibrils in the porous fluorine resin membrane, and the adhesion points act as starting points for an atmospheric dust component to aggregate and spread, thereby leading to clogging of the porous fluorine resin membrane. This increases the pressure drop of the filter medium.

The present invention provides an air filter medium including a porous fluorine resin membrane, the air filter medium further including a glass filter medium layer, wherein
the glass filter medium layer and the porous fluorine resin membrane are placed in this order from upstream to downstream of the air filter medium configured to allow airflow to pass through the air filter medium,
the porous fluorine resin membrane includes a plurality of nodes and a plurality of fibrils, and in an area distribution of the nodes, when an area of the node corresponding to a cumulative relative frequency of 95% from a smaller area is defined as S95, the porous fluorine resin membrane satisfies 2.0 μm²≤S95≤8.0 μm².

Another aspect of the present invention provides a filter pleat pack including an air filter medium folded into pleats, wherein
the air filter medium is the air filter medium according to the present invention.

Yet another aspect of the present invention provides an air filter unit including an air filter medium, wherein
the air filter medium is the air filter medium according to the present invention.

Yet another aspect of the present invention provides an air filter unit including a filter pleat pack, wherein
the filter pleat pack is the filter pleat pack according to the present invention.

### Advantageous Effects of Invention

According to the present invention, it is possible to provide an air filter medium including a porous fluorine resin membrane and suitable, even in an environment containing fine particles having a particle size of approximately 0.1 μm, for suppressing an increase in pressure drop while suppressing a reduction in collection efficiency.

### BRIEF DESCRIPTION OF DRAWINGS

FIG. 1 is a cross-sectional view schematically showing an example of the air filter medium of the present invention.

FIG. 2 is a diagram illustrating image processing for identifying an inscribed circle inscribed in a node-free region.

FIG. 3 is a cross-sectional view schematically showing another example of the air filter medium of the present invention.

FIG. 4 is a cross-sectional view schematically showing yet another example of the air filter medium of the present invention.

FIG. 5 is a cross-sectional view schematically showing yet another example of the air filter medium of the present invention.

FIG. 6 is a cross-sectional view schematically showing yet another example of the air filter medium of the present invention.

FIG. 7 is a perspective view schematically showing an example of the filter pleat pack of the present invention.

FIG. 8 is a perspective view schematically showing an example of the air filter unit of the present invention.

FIG. 9A is a scanning electron microscope (SEM) image of a porous PTFE membrane used in the air filter medium of Example 1.

FIG. 9B is an SEM image of a porous PTFE membrane used in the air filter medium of Example 2.

FIG. 9C is an SEM image of a porous PTFE membrane used in the air filter medium of Example 3.

FIG. 9D is an SEM image of a porous PTFE membrane used in the air filter medium of Example 4.

FIG. 10A is an SEM image of a porous PTFE membrane used in the air filter medium of Comparative Example 1.

FIG. 10B is an SEM image of a porous PTFE membrane used in the air filter medium of Comparative Example 2.

FIG. 11A is a node-only image obtained through fibril removal processing on a binarized image obtained from the SEM image of FIG. 9B.

FIG. 11B is an image in which inscribed circles were identified from the node-only image of FIG. 11A.

FIG. 12A is a frequency distribution chart of the areas of the nodes in the porous PTFE membrane of Example 2, obtained based on the node-only image of FIG. 11A.

FIG. 12B is a cumulative relative frequency distribution chart of the areas of the nodes in the porous PTFE membrane of Example 2, obtained based on the node-only image of FIG. 11A.

FIG. 13A is a frequency distribution chart of the diameters of the inscribed circles in the porous PTFE membrane of Example 2, obtained based on the image of FIG. 11B in which the inscribed circles were identified.

FIG. 13B is a cumulative relative frequency distribution chart of the diameters of the inscribed circles in the porous PTFE membrane of Example 2, obtained based on the image of FIG. 11B in which the inscribed circles were identified.

FIG. 14 is a graph showing the relationship between an area S95 of the node and the PAO retention amount in the porous PTFE membranes used in the air filter media of the examples and comparative examples.

FIG. 15 is a graph showing the relationship between a diameter D50 of the inscribed circle and the PAO retention amount in the porous PTFE membranes used in the air filter media of the examples and comparative examples.

FIG. 16 is a graph showing the relationship between the area S95 of the node and the diameter D50 of the inscribed circle in the porous PTFE membranes used in the air filter media of the examples and comparative examples, together with the PAO retention amount and the collection efficiency.

FIG. 17 is an SEM image showing an example of a porous fluorine resin membrane after an atmospheric dust test.

### DESCRIPTION OF EMBODIMENTS

An air filter medium according to a first aspect of the present invention is an air filter medium including a porous fluorine resin membrane, the air filter medium further including a glass filter medium layer, wherein
the glass filter medium layer and the porous fluorine resin membrane are placed in this order from upstream to downstream of the air filter medium configured to allow airflow to pass through the air filter medium,
the porous fluorine resin membrane includes a plurality of nodes and a plurality of fibrils, and in an area distribution of the nodes, when an area of the node corresponding to a cumulative relative frequency of 95% from a smaller area is defined as S95, the porous fluorine resin membrane satisfies 2.0 μm²≤S95≤8.0 μm².

In a second aspect of the present invention, for example, in the air filter medium according to the first aspect, in a diameter distribution of inscribed circles inscribed in a region free of the nodes, when a diameter of the inscribed circle corresponding to a cumulative relative frequency of 50% from a smaller diameter is defined as D50, the porous fluorine resin membrane satisfies D50>5.0 μm.

In a third aspect of the present invention, for example, in the air filter medium according to the first or second aspect, the porous fluorine resin membrane has an initial pressure drop of 100 Pa or less when air is allowed to pass through the porous fluorine resin membrane at a linear velocity of 5.3 cm/s.

In a fourth aspect of the present invention, for example, in the air filter medium according to any one of the first to third aspects, the porous fluorine resin membrane has a collection efficiency of 95.0% or more as measured at a permeate flow rate of 5.3 cm/s using polyalphaolefin particles that are monodisperse particles having a number peak at a particle size of 0.1 μm.

In a fifth aspect of the present invention, for example, in the air filter medium according to any one of the first to fourth aspects, when a change in pressure drop of the porous fluorine resin membrane is measured by allowing polyalphaolefin particles that are polydisperse particles having a number peak in a particle size range of 0.1 to 0.2 μm to pass through the porous fluorine resin membrane at a concentration of 0.2 to 0.5 g/m³ and a linear velocity of 5.3 cm/s, an amount of the polyalphaolefin particles collected by the porous fluorine resin membrane when the pressure drop reaches 500 Pa is 6.0 g/m² or more.

In a sixth aspect of the present invention, for example, the air filter medium according to any one of the first to fifth aspects further includes a first air-permeable supporting layer placed between the glass filter medium layer and the porous fluorine resin membrane.

In a seventh aspect of the present invention, for example, the air filter medium according to any one of the first to sixth aspects further includes a second air-permeable supporting layer placed on a downstream side in a direction of the airflow with respect to the porous fluorine resin membrane.

In an eighth aspect of the present invention, for example, in the air filter medium according to any one of the first to seventh aspects, the porous fluorine resin membrane is a porous polytetrafluoroethylene membrane.

In a ninth aspect of the present invention, for example, the air filter medium according to any one of the first to eighth aspects includes the one porous fluorine resin membrane.

A filter pleat pack according to a tenth aspect of the present invention is a filter pleat pack including an air filter medium folded into pleats, wherein
the air filter medium is the air filter medium according to any one of the first to ninth aspects.

An air filter unit according to an eleventh aspect of the present invention is an air filter unit including an air filter medium, wherein
the air filter medium is the air filter medium according to any one of the first to ninth aspects.

An air filter unit according to a twelfth aspect of the present invention is an air filter unit including a filter pleat pack, wherein
the filter pleat pack is the filter pleat pack according to the tenth aspect.

Embodiments of the present invention are described below with reference to the drawings. The present invention is not limited to the following embodiments.

### [Air Filter Medium]

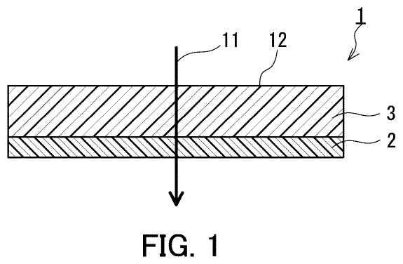

FIG. 1 shows an example of the air filter medium of the present embodiment. An air filter medium 1 of FIG. 1 is a filter medium including a porous fluorine resin membrane 2. The air filter medium 1 further includes a glass filter medium layer 3. The glass filter medium layer 3 and the porous fluorine resin membrane 2 are placed in this order from upstream to downstream of the air filter medium 1 configured to allow airflow 11 to pass through the air filter medium 1. In other words, the glass filter medium layer 3 is placed on the upstream side in a direction of the airflow 11 with respect to the porous fluorine resin membrane 2. The air filter medium 1 of FIG. 1 includes one glass filter medium layer 3 and one porous fluorine resin membrane 2.

### (Porous Fluorine Resin Membrane)

The porous fluorine resin membrane 2 can function as a main filter of the air filter medium 1. The porous fluorine resin membrane 2 generally functions as a surface filtration medium that collects a collection object at its surface portion.

The porous fluorine resin membrane 2 includes a plurality of fluorine resin fibrils, which are fine fibrous structures, and a plurality of fluorine resin nodes connected to the fibrils.

In the area distribution of the nodes, when the area of the node corresponding to a cumulative relative frequency of 95% from a smaller area is defined as S95, the porous fluorine resin membrane 2 satisfies 2.0 μm²≤S95≤8.0 μm².

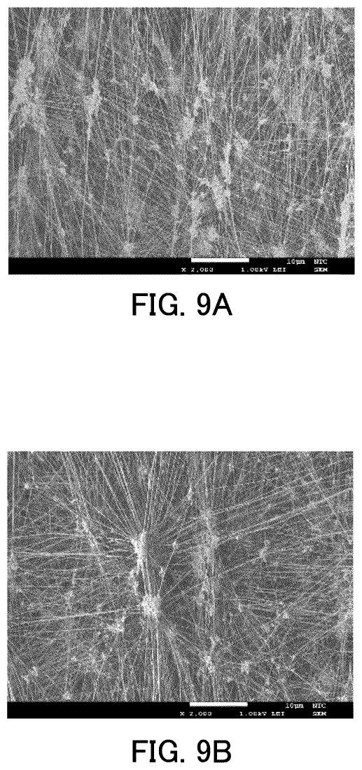

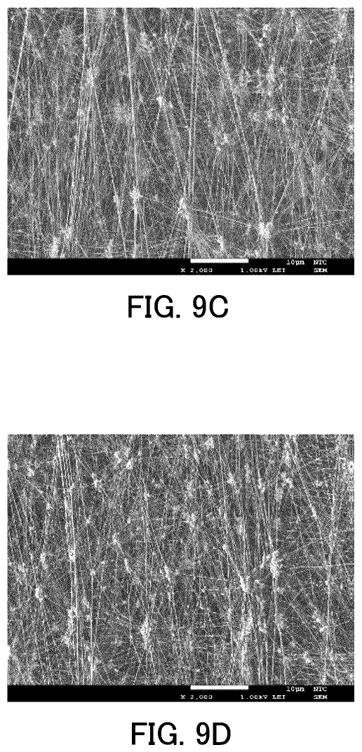

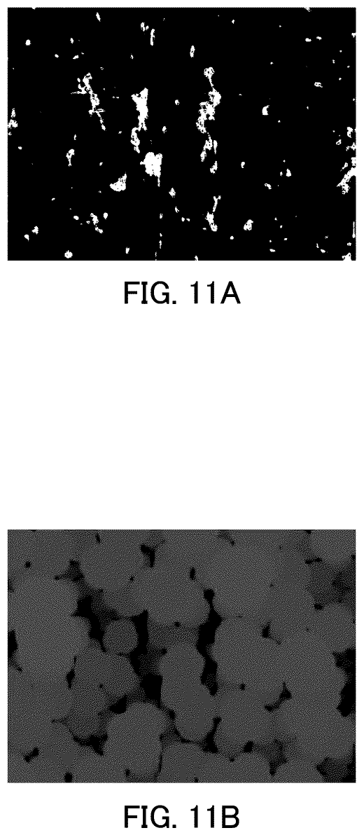

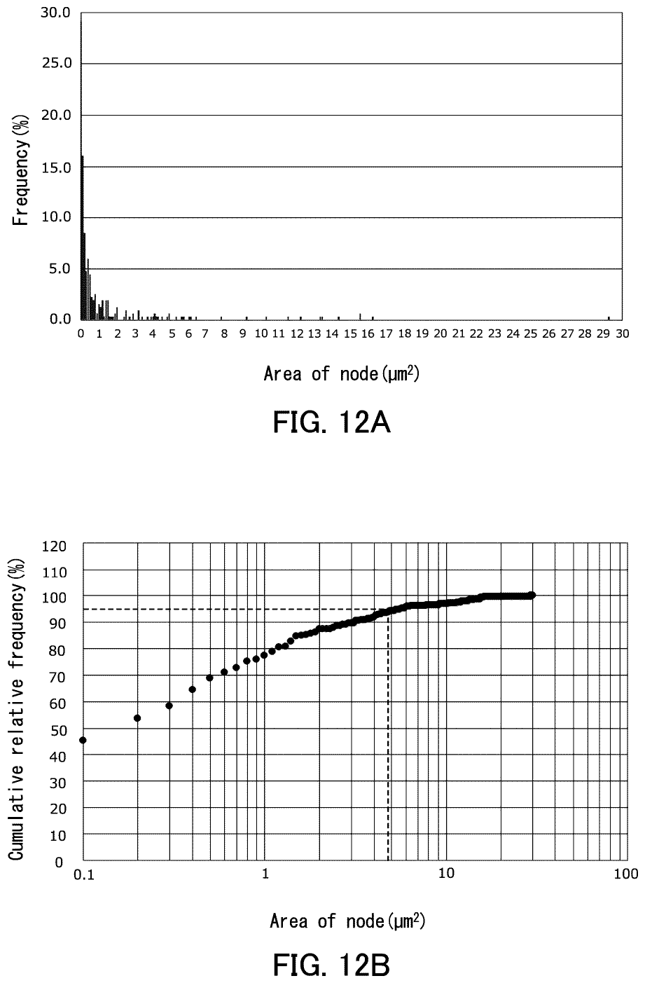

In the present embodiment, the size of a node is represented by the area of the node. The area S95 of the node can be calculated by the method described below. First, the surface of the porous fluorine resin membrane 2 is observed using a scanning electron microscope (SEM) (see, for example, FIG. 9B). Next, the obtained SEM image (or a portion thereof) is binarized using image processing software (e.g., ImageJ). The obtained binarized image is subjected to fibril removal processing to create a node-only image that contains only nodes (see, for example, FIG. 11A). In the fibril removal processing, the binarized image is magnified and the fibril region is blacked out. Thus, the fibrils can be removed. For n nodes contained in the obtained node-only image, the area of each node is calculated. Based on the obtained data, a frequency distribution chart (histogram) is created, where the horizontal axis represents area of node (μm²) and the vertical axis represents frequency (%) (see, for example, FIG. 12A). Next, the cumulative relative frequency (%) is calculated based on the frequency data and a cumulative relative frequency distribution chart is created, where the horizontal axis represents area of node (μm²) and the vertical axis represents cumulative relative frequency (%) (see, for example, FIG. 12B). In the cumulative relative frequency distribution chart, the area of the node corresponding to a cumulative relative frequency of 95% from a smaller area is defined as S95. To obtain the area distribution of the nodes, it is required to use an observation image with a field of view that is sufficiently large to determine that the entire surface of the porous fluorine resin membrane 2 is observed. For example, an observation image in which at least 50 nodes (n=50) are contained can be used to calculate the area S95 of the node.

Studies conducted by the present inventors have revealed that when the area S95 of the node in the porous fluorine resin membrane 2 satisfies 2.0 μm²≤S95≤8.0 μm², it is possible to suppress an increase in pressure drop while suppressing a reduction in collection efficiency, even in an environment containing fine particles having a particle size of approximately 0.1 μm. FIG. 17 is an SEM image showing an example of a porous fluorine resin membrane after an atmospheric dust test (magnification: 5000 times). In FIG. 17, the light gray portions represent particles such as dust adhering to fibrils and nodes. As shown in FIG. 17, fine particles contained in the atmosphere adhere not only to the fibrils but also to the nodes connected to the fibrils in the porous fluorine resin membrane. Here, “the area S95 of the node satisfies 2.0 μm²≤S95≤8.0 μm²” means that, in the area distribution of the nodes, the nodes having areas exceeding the area of the node corresponding to a cumulative relative frequency of 95% from a smaller area, that is, the remaining 5% of the nodes, each have an area greater than 8.0 μm² (see, for example, FIG. 12B). The present inventors have found that when the remaining 5% of the nodes are excessively large in size, a phenomenon occurs where collection efficiency is locally reduced in that portion. This phenomenon reduces the overall collection efficiency of the porous fluorine resin membrane 2. On the other hand, when the remaining 5% of the nodes are excessively small in size, the amount of fine particles collected in that portion is further reduced. This reduces the total amount of fine particles collected by the porous fluorine resin membrane 2, increasing the pressure drop. In the porous fluorine resin membrane 2 of the present embodiment, the area S95 of the node is adjusted within the range of 2.0 μm²≤S95≤8.0 μm², thereby suppressing the localized presence of nodes that are excessively large in size and the localized presence of nodes that are excessively small in size. Accordingly, in the porous fluorine resin membrane 2, a reduction in collection efficiency is suppressed while an increase in pressure drop is suppressed.

The lower limit of the area S95 of the node may be 2.5 μm², 3.0 μm², 3.5 μm², or even 4.0 μm². The upper limit of the area S95 of the node may be 7.5 μm², 7.0 μm², 6.5 μm², or even 6.0 μm².

In the diameter distribution of the inscribed circles inscribed in a node-free region that is free of the nodes, when the diameter of the inscribed circle corresponding to a cumulative relative frequency of 50% from a smaller diameter is defined as D50, the porous fluorine resin membrane 2 may satisfy D50≥3.0 μm.

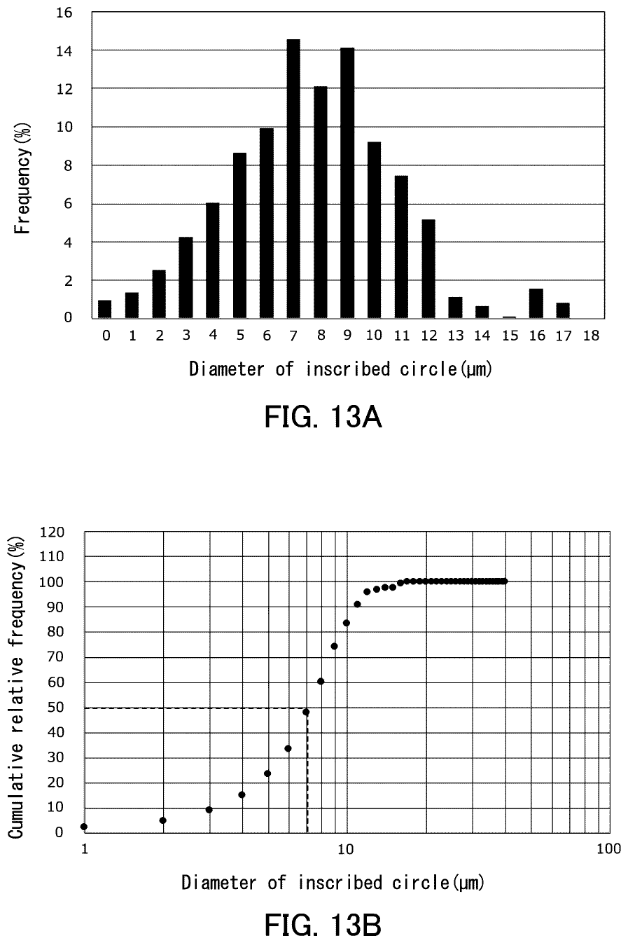

In the present embodiment, the distance between adjacent nodes is represented by the diameter of an inscribed circle inscribed in the node-free region. That is, in the present embodiment, the diameter D50 of the inscribed circle is defined as the distance between nodes. The diameter D50 of the inscribed circle can be calculated by the method described below. First, the surface of the porous fluorine resin membrane 2 is observed using an SEM (see, for example, FIG. 9B). Next, the obtained SEM image (or a portion thereof) is binarized using image processing software (e.g., ImageJ). The obtained binarized image is subjected to fibril removal processing to create a node-only image (see, for example, FIG. 11A). From the obtained node-only image, an inscribed circle inscribed in a node-free region is identified (see, for example, FIG. 11B). The identifying method for the inscribed circle in the node-only image is described later. For m inscribed circles contained in the image in which the inscribed circles are identified, the diameter of each inscribed circle is calculated. Based on the obtained data, a frequency distribution chart (histogram) is created, where the horizontal axis represents diameter of inscribed circle (μm) and the vertical axis represents frequency (%) (see, for example, FIG. 13A). Next, the cumulative relative frequency (%) is calculated based on the frequency data and a cumulative relative frequency distribution chart is created, where the horizontal axis represents diameter of inscribed circle (μm) and the vertical axis represents cumulative relative frequency (%) (see, for example, FIG. 13B). In the cumulative relative frequency distribution chart, the diameter of the inscribed circle corresponding to a cumulative relative frequency of 50% from a smaller diameter is defined as D50. To obtain the diameter distribution of the inscribed circles, it is required to use an observation image with a field of view that is sufficiently large to determine that the entire surface of the porous fluorine resin membrane 2 is observed. Furthermore, for example, an image in which at least 1,000,000 (m=1,000,000) inscribed circles are identified can be used to calculate the diameter D50 of the inscribed circle.

An inscribed circle inscribed in a node-free region can be identified by the method described below. First, a pixel at any one point is selected from a node-free region in a node-only image, and a circle centered at the point is drawn. The diameter of the circle is increased until its circumference comes into contact with the node nearest to the point. The circle, obtained when the circle comes into contact with the node, is overwritten onto the image data as an “inscribed circle inscribed in the node-free region”. This operation is performed for all the pixels in the node-free region. However, when a newly drawn inscribed circle overlaps one or more already drawn inscribed circles, it is processed in the following manner. (i) When a new inscribed circle overlaps an existing inscribed circle having an equal or smaller diameter, the new inscribed circle is overwritten onto the image data; and (ii) when the new inscribed circle overlaps an existing inscribed circle having a larger diameter, the new inscribed circle is not overwritten. Accordingly, when the new inscribed circle overlaps both the inscribed circle having an equal or smaller diameter and the inscribed circle having a larger diameter, the new inscribed circle is overwritten except for the region overlapping the inscribed circle having a larger diameter.

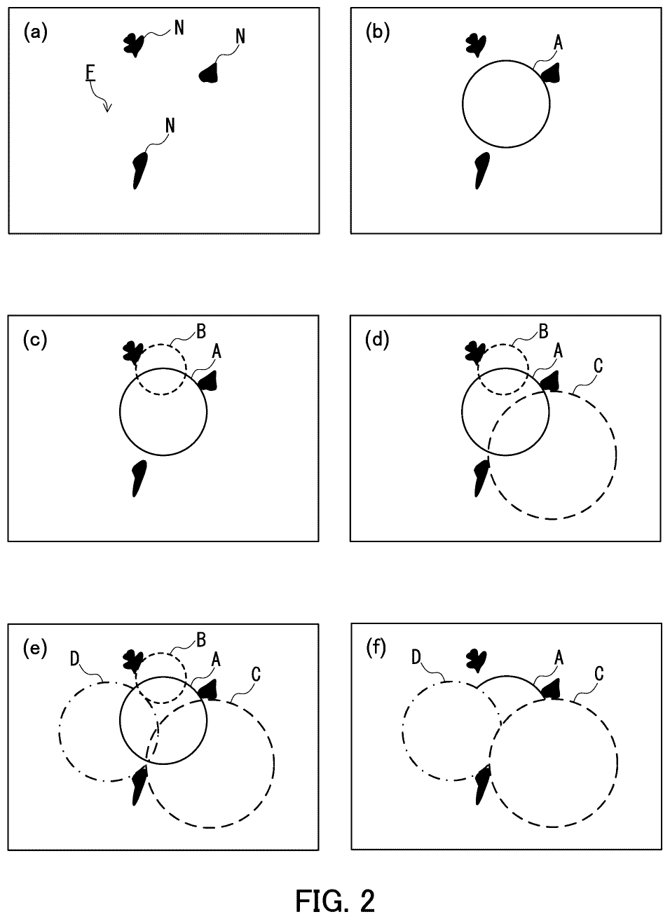

FIG. 2 is a diagram illustrating image processing for identifying an inscribed circle inscribed in a node-free region. The image processing is described in detail below with reference to FIG. 2. In FIG. 2, reference sign N represents a node and reference sign F represents a node-free region. FIG. 2(a) shows a node-only image. For convenience, in FIG. 2(a), the actual node-only image is displayed with reversed black and white colors. First, as shown in FIG. 2(b), any one point is selected and an inscribed circle A inscribed in a node-free region F is drawn. Next, as shown in FIG. 2(c), another point is selected and an inscribed circle B is drawn. In this case, the existing circle A is larger than the circle B, and accordingly the circle B is not overwritten onto the image data. Similarly, as shown in FIG. 2(d), yet another point is selected and an inscribed circle C is drawn. In this case, the circle C is larger than the existing circle A, and accordingly the circle C is overwritten onto the image data. Similarly, as shown in FIG. 2(e), yet another point is selected and an inscribed circle D is drawn. In this case, the circle C>the circle D>the circle A is satisfied, and accordingly the circle D is overwritten onto the image data except for the region overlapping the circle C. Thus, the image data after the above processing is as shown in FIG. 2(f). By repeating such processing, the inscribed circles inscribed in the node-free region F can be identified. Such image processing can be performed using image processing software (e.g., ImageJ).

Studies conducted by the present inventors have revealed that, in the porous fluorine resin membrane 2, when the diameter D50 of the inscribed circle satisfies D50≥3.0 μm, that is, when the distance between nodes is 3.0 μm or more, an increase in pressure drop can be further suppressed. In a porous fluorine resin membrane, when the distance between adjacent nodes is excessively small, fine particles adhering to the nodes are likely to serve as starting points for an atmospheric dust component to aggregate and spread, leading to clogging. This increases pressure drop. In the porous fluorine resin membrane 2 of the present embodiment, the distance between nodes is adjusted within a range of 3.0 μm or more, and accordingly an appropriate space is ensured between nodes. This further suppresses an increase in the pressure drop of the porous fluorine resin membrane 2.

The lower limit of the diameter D50 of the inscribed circle may be 3.5 μm, 4.0 μm, 4.5 μm, or even 5.0 μm.

The diameter D50 of the inscribed circle may be greater than 5.0 μm. That is, the porous fluorine resin membrane 2 may satisfy D50>5.0 μm. In the porous fluorine resin membrane 2, when the diameter D50 of the inscribed circle satisfies D50>5.0 μm, that is, when the distance between nodes is greater than 5.0 μm, an increase in pressure drop can be even further suppressed.

The upper limit of the diameter D50 of the inscribed circle is, for example, 10.0 μm. By setting the upper limit of the diameter D50 of the inscribed circle to 10.0 μm, a reduction in collection efficiency due to an excessively large distance between nodes is suppressed. The upper limit of the diameter D50 of the inscribed circle may be 9.0 μm.

The porous fluorine resin membrane 2 is formed primarily of a fluorine resin. “Formed primarily of a fluorine resin” means that the fluorine resin content is the highest among all the components contained in the porous fluorine resin membrane 2. The fluorine resin content in the porous fluorine resin membrane 2 is, for example, 50 weight % or more and may be 60 weight % or more, 70 weight % or more, 80 weight % or more, 90 weight % or more, or even 95 weight % or more. The porous fluorine resin membrane 2 can include, for example, a filler in addition to the fluorine resin.

Examples of the fluorine resin include PTFE, an ethylene-tetrafluoroethylene-hexafluoropropylene copolymer (EFEP), a tetrafluoroethylene-hexafluoropropylene-vinylidene fluoride copolymer (THV), a tetrafluoroethylene-hexafluoropropylene copolymer (FEP), a tetrafluoroethylene-perfluoroalkoxyethylene copolymer (PFA), and an ethylene-tetrafluoroethylene copolymer (ETFE).

The porous fluorine resin membrane 2 may include two or more fluorine resins.

The porous fluorine resin membrane 2 may be a porous PTFE membrane.

The porous fluorine resin membrane 2 may have an initial pressure drop PD₀ of 100 Pa or less when air is allowed to pass through the porous fluorine resin membrane 2 at a linear velocity of 5.3 cm/s. The pressure drop PD₀ may be 95 Pa or less or 90 Pa or less.

The lower limit of the pressure drop PD₀ is, for example, 30 Pa and may be 40 Pa.

Pressure drop PD of each of the air filter medium 1 and the layers included in the air filter medium 1 can be evaluated in the following manner. The filter medium or layer that is an evaluation object is set in a circular holder having an effective area of 100 cm². Air is allowed to pass through the set evaluation object, and the pressure drop at the linear velocity of the passing air adjusted to 5.3 cm/s using a flow meter is measured using a pressure gauge (manometer). Note that, in evaluating the pressure drop PD of the air filter medium 1, air is allowed to flow in the direction from the glass filter medium layer 3 toward the porous fluorine resin membrane 2. The pressure drop is measured for each evaluation object, and the measured value is defined as the pressure drop PD.

The porous fluorine resin membrane 2 may have a collection efficiency CE of 95.0% or more as measured at a permeate flow rate of 5.3 cm/s using polyalphaolefin (PAO) particles that are monodisperse particles having a number peak at a particle size of 0.1 μm (hereinafter referred to as “monodisperse PAO particles”). The collection efficiency CE may be 95.5% or more, 96.0% or more, or even 96.5% or more.

The upper limit of the collection efficiency CE is, for example, 99.9%.

The collection efficiency CE of each of the air filter medium 1 and the layers included in the air filter medium 1 can be evaluated in the following manner. The filter medium or layer that is an evaluation object is set in a circular holder having an effective area of 100 cm². Air is allowed to pass through the set evaluation object, and the linear velocity of the passing air is adjusted to 5.3 cm/s using a flow meter. Note that, in evaluating the collection efficiency CE of the air filter medium 1, air is allowed to flow in the direction from the glass filter medium layer 3 toward the porous fluorine resin membrane 2. Then, monodisperse PAO particles are introduced into the air passing through the evaluation object such that the concentration of particles having a particle size of 0.1 μm is 1×10⁷ particles/L or more. The monodisperse PAO particles can be generated, for example, using a constant-output aerosol atomizer. After that, the concentration of monodisperse PAO particles contained in the air having passed through the evaluation object is measured using a particle counter placed downstream of the holder. The collection efficiency CE of the evaluation object is calculated by the following equation (1). The upstream particle concentration can be determined by allowing the above air, into which the monodisperse PAO particles are introduced, to flow with the evaluation object not set in the holder, and by analyzing the air using the above particle counter.

$$Collection efficiency C E = [ 1 - ( downstream particle concentration ) \text{} / upstream particle concentration ) ] \times 100 ( \% ) \qquad ( 1 )$$

When the change in the pressure drop of the porous fluorine resin membrane 2 is measured by allowing PAO particles that are polydisperse particles having a number peak in a particle size range of 0.1 to 0.2 μm (hereinafter referred to as “polydisperse PAO particles”) to pass through the porous fluorine resin membrane 2 at a concentration of 0.2 to 0.5 g/m³ and a linear velocity of 5.3 cm/s, the amount of polydisperse PAO particles collected by the porous fluorine resin membrane 2 when the pressure drop reaches 500 Pa (hereinafter referred to as “PAO retention amount”) may be 5.0 g/m² or more, 5.5 g/m² or more, or even 6.0 g/m² or more. The PAO retention amount may be 6.5 g/m² or more. Note that 500 Pa corresponds to a typical pressure drop at which replacement of the air filter medium is considered.

The upper limit of the PAO retention amount is not particularly limited. The upper limit of the PAO retention amount is, for example, 200 g/m². A larger PAO retention amount tends to increase the extent to which the above increase in pressure drop is suppressed. By setting the PAO retention amount of the porous fluorine resin membrane 2 to 6.0 g/m² or more, for example, the air filter medium 1 can have an extended service life when used in an environment containing fine particles having a particle size of approximately 0.1 μm.

The PAO retention amount of each of the air filter medium 1 and the layers included in the air filter medium 1 can be evaluated in the following manner. The filter medium or layer that is an evaluation object is set in a holder described above and used for evaluation of the pressure drop PD and the collection efficiency CE. The weight (initial weight W₀) of the evaluation object is measured before being set. Next, air is allowed to pass through the set evaluation object, and the linear velocity of the passing air is adjusted to 5.3 cm/s using a flow meter. Note that, in evaluating the PAO retention amount of the air filter medium 1, air is allowed to flow in the direction from the glass filter medium layer 3 toward the porous fluorine resin membrane 2. Then, polydisperse PAO particles are introduced into the air passing through the evaluation object at a concentration of 0.2 to 0.5 g/m³ so as to be collected by the evaluation object. Measurement of the pressure drop of the evaluation object using a pressure gauge (manometer) is then started. The linear velocity of the air passing through the evaluation object is maintained at 5.3 cm/s. At a moment when the measured pressure drop reaches 500 Pa, the flow of the air passing through the evaluation object is stopped. Subsequently, the evaluation object is removed from the holder, and its weight (reached weight) W₁ (g) is measured. The PAO retention amount of the evaluation object can be determined by substituting the initial weight W₀ (g) and the measured reached weight W₁ (g) of the evaluation object into the following equation (2).

$$PAO retention amount ( g / {m}^{2} ) = [ \text{} reached weight {W}_{1} ( g ) - initial weight {W}_{0} ( g ) ] / ( 100 {cm}^{2} \times 1 {0}^{- 4} ) \qquad ( 2 )$$

The thickness of the porous fluorine resin membrane 2 is, for example, 1 to 100 μm. The thickness of the porous fluorine resin membrane 2 may be 2 to 50 μm, 3 to 20 μm, or even 5 to 15 μm.

The porosity of the porous fluorine resin membrane 2 is, for example, 70 to 98%. The porosity of the porous fluorine resin membrane 2 may be 80 to 98%, 90 to 98%, or even 93 to 98%. The porosity can be measured in the following manner. The porous fluorine resin membrane 2 that is an evaluation object is cut to given dimensions (e.g., 6-cm-diameter circle), and its volume and mass are determined. The porosity can be calculated by substituting the determined volume and mass into the following equation (3). In the equation (3), V (unit: cm³) represents the volume, W (unit: g) represents the mass, and D (unit: g/cm³) represents true density of the fluorine resin.

$$Porosity ( \% ) = 100 \times [ V - ( W / D ) ] / V \qquad ( 3 )$$

The average pore diameter of the porous fluorine resin membrane 2 is, for example, 1.8 to 2.5 μm. The average pore diameter of the porous fluorine resin membrane 2 may be 2.0 to 2.5 μm. The average pore diameter can be measured by a method according to ASTM (American Society for Testing and Materials) F316-86.

The grammage (weight per unit area) of the porous fluorine resin membrane 2 is, for example, 0.05 to 10 g/m² and may be 0.1 to 5 g/m² or even 0.3 to 3 g/m².

The average fiber diameter of the porous fluorine resin membrane 2 (average fiber diameter of fibrils) is, for example, 0.2 μm or less and may be 0.15 μm or less or even 0.1 μm or less. The lower limit of the average fiber diameter is, for example, 0.05 μm or more and may be 0.07 μm or more. The porous fluorine resin membrane 2 having a smaller average fiber diameter generally has higher collection performance. The collection performance can be represented by the PF value, and a higher PF value indicates higher collection performance. Herein, the average fiber diameter of a fibrous material is defined as the average diameter of at least 20 fibers randomly selected from a magnified image of the surface and/or cross-section of a layer formed of the fibrous material. The magnified image is, for example, a microscope image obtained using a scanning electron microscope (SEM), a laser microscope, or the like. The magnification of the magnified image is, for example, approximately 100 to 500 times. The diameter of each selected fiber can be determined as the fiber width in a direction perpendicular to the direction in which the fiber extends, for example, by image analysis.

The PF (performance factor) value determined for the porous fluorine resin membrane 2 by the following equation (4) is, for example, 16 or more and may be 17 or more or even 18 or more. The upper limit of the PF value is, for example, 50 or less and may be 48 or less or even 45 or less. In the equation (4), PD represents the initial pressure drop, and CE represents the collection efficiency. Note that the unit of pressure drop PD in the equation (4) is mmH₂O.

$$P F value = \{ - log [ ( 100 - C E ) / 100 ] / P D \} \times 100 \qquad ( 4 )$$

The porous fluorine resin membrane 2 of FIG. 1 is a single layer. The porous fluorine resin membrane 2 may be a laminate composed of two or more identical or different layers.

The air filter medium 1 of FIG. 1 includes one porous fluorine resin membrane 2. However, the air filter medium 1 may include an additional porous fluorine resin membrane other than the porous fluorine resin membrane 2.

In the air filter medium 1 of FIG. 1, one outermost layer is the glass filter medium layer 3, while the other outermost layer is the porous fluorine resin membrane 2.

### (Production Method for Porous Fluorine Resin Membrane)

The porous fluorine resin membrane 2 of the present embodiment can be produced by the method described below. The porous fluorine resin membrane 2 can be formed, for example, by shaping a mixture of an unsintered fluorine resin powder and a liquid lubricant into a film by a method such as extrusion and/or rolling, removing the liquid lubricant from the obtained unsintered film, and then biaxially stretching the unsintered film. At any time after the formation of the unsintered film, sintering may be performed in which the film is heated to a temperature equal to or higher than the melting point of the fluorine resin. Examples of the liquid lubricant include hydrocarbon oils, such as naphtha, white oil, and liquid paraffin. However, the liquid lubricant is not limited as long as the liquid lubricant can wet the surfaces of the fluorine resin particles and be removed later.

One preferred example of the biaxial stretching is a combination of stretching at a stretch ratio R_{MD} of 2 to 60 and a stretching temperature T_{MD} of 150 to 390° C. in the machine direction (MD) of the unsintered film and stretching at a stretch ratio R_{TD} of 10 to 60 and a stretching temperature T_{TD} of 100 to 250° C. in the transverse direction (TD) of the film. The porous fluorine resin membrane 2 thus produced has appropriately adjusted node sizes and distances between nodes. Specifically, the porous fluorine resin membrane 2 thus produced can satisfy 2.0 μm²≤S95≤8.0 μm² and D50≥3.0 μm. However, the production method for the porous fluorine resin membrane 2 is not limited as long as collection performance suitable for the intended use of the air filter medium 1 can be obtained.

In the biaxial stretching, the area magnification represented by R_{MD}×R_{TD} is preferably in the range of 150 to 300 times. Studies conducted by the present inventors have revealed that the area magnification in the biaxial stretching affects the average pore diameter of the porous fluorine resin membrane 2. Increasing the area magnification tends to increase the average pore diameter, whereas reducing the area magnification tends to reduce the average pore diameter. Setting the area magnification to 150 times or more suppresses a reduction in the collection amount of fine particles and thus an increase in pressure drop, both of which are due to an excessively small average pore diameter of the porous fluorine resin membrane 2. Setting the area magnification to 300 times or less suppresses a reduction in collection efficiency due to an excessively large average pore diameter of the porous fluorine resin membrane 2. The area magnification in the biaxial stretching may be in the range of 200 to 300 times or 250 to 300 times.

The stretch ratio R_{MD} in the machine direction may be 5 to 40 or 10 to 30.

The stretch ratio R_{TD} in the transverse direction may be 10 to 40 or 10 to 30.

The R_{TD}/R_{MD} ratio of the stretch ratio R_{TD} in the transverse direction to the stretch ratio R_{MD} in the machine direction may be 1.2 to 2.2 or 1.5 to 2.0.

The stretch temperature T_{MD} in the machine direction may be 150 to 300° C.

As described above, the stretching temperature T_{TD} in the transverse direction is preferably 100 to 250° C. Studies conducted by the present inventors have revealed that the stretching temperature T_{TD} in the transverse direction affects node division in unsintered films. Reducing the stretching temperature T_{TD} in the transverse direction promotes node division, tending to result in reduced node sizes and reduced distances between nodes. Increasing the stretching temperature T_{TD} in the transverse direction suppresses node division, tending to result in increased node sizes and increased distances between nodes. Based on these findings, the present inventors have found that by adjusting the stretching temperature T_{TD} in the transverse direction, it is possible to adjust the distances between nodes in the resulting porous fluorine resin membrane 2. The stretching temperature T_{TD} in the transverse direction may be 100 to 240° C.

In the biaxial stretching, the strain rate SR_{TD} in the stretching of the unsintered film in the transverse direction is preferably 40 to 120%/s. Here, the “strain rate” means the amount of dimensional change in the stretching direction per unit time. Studies conducted by the present inventors have revealed that the strain rate SR_{TD} in the transverse direction in addition to the stretching temperature T_{TD} in the transverse direction affects node division in unsintered films. Increasing the strain rate SR_{TD} promotes node division, tending to result in reduced node sizes and reduced distances between nodes. Reducing the strain rate SR_{TD} suppresses node division, tending to result in increased node sizes and increased distances between nodes. Based on these findings, the present inventors have found that by adjusting the strain rate SR_{TD} in the transverse direction in addition to adjusting the stretching temperature T_{TD} in the transverse direction, it is possible to adjust the distances between nodes in the resulting porous fluorine resin membrane 2 within a more desirable range. The strain rate SR_{TD} in the transverse direction may be 60 to 100%/s.

### (Glass Filter Medium Layer)

The glass filter medium layer 3 can function as a prefilter that collects a portion of a collection object contained in the airflow 11. The collection object includes fine particles having a particle size of approximately 0.1 μm. The glass filter medium layer 3 generally functions as a depth filtration medium that collects the collection object within the layer.

The glass filter medium layer 3 is typically formed of a fibrous material including glass fibers. The glass filter medium layer 3 may include glass fibers. The glass filter medium layer 3 may be a glass nonwoven fabric including glass fibers.

The average fiber diameter of the glass fibers may be 0.5 to 2.0 μm. For the same grammage, the smaller the average fiber diameter is, the higher the collection performance of the glass filter medium layer 3 is.

The average fiber diameter may be substantially uniform in the thickness direction of the glass filter medium layer 3. Herein, the average fiber diameter is considered substantially uniform even with a difference of 20% or less, preferably 10% or less. The difference is expressed by an expression (Dₘₐₓ−Dₘᵢₙ)/Dₘᵢₙ), where Dₘᵢₙ represents the minimum average fiber diameter and Dₘₐₓ represents the maximum average fiber diameter among multiple average fiber diameters D under comparison.

The glass filter medium layer 3 may include a material other than those described above. An example of the material is a binder for binding the fibers in the glass filter medium layer 3 formed of the fibrous material. The binder is typically formed of a resin. Examples of the resin include an acrylic resin, a polyvinyl alcohol resin, and a polyethylene oxide resin.

The thickness of the glass filter medium layer 3 is, for example, 100 to 500 μm and may be 200 to 450 μm or even 250 to 400 μm.

The grammage (weight per unit area) of the glass filter medium layer 3 is, for example, 20 to 100 g/m² and may be 30 to 90 g/m² or even 40 to 80 g/m².

The initial pressure drop PD₀ of the glass filter medium layer 3 at a permeate flow rate of 5.3 cm/s is, for example, 15 to 175 Pa and may be 30 to 110 Pa.

The collection efficiency CE of the glass filter medium layer 3 as measured at a permeate flow rate of 5.3 cm/s using monodisperse PAO particles is, for example, 40 to 99% and may be 60 to 95%. The glass filter medium layer 3 can generally have higher collection performance than a prefilter formed of a nonwoven fabric formed of a resin fiber.

When the change in the pressure drop of the glass filter medium layer 3 is measured by allowing polydisperse PAO particles to pass through the glass filter medium layer 3 at a concentration of 0.2 to 0.5 g/m³ and a linear velocity of 5.3 cm/s, the amount of polydisperse PAO particles collected by the glass filter medium layer 3 when the pressure drop reaches 500 Pa (hereinafter referred to as “PAO retention amount”) is, for example, 50 g/m² or more and may be 60 g/m² or more, 70 g/m² or more, 80 g/m² or more, 90 g/m² or more, or even 100 g/m² or more. The upper limit of the PAO retention amount is, for example, 200 g/m² or less.

The PF value determined for the glass filter medium layer 3 by the above equation (4) is, for example, 3 to 15 and may be 5 to 12 or even 10 to 12. The PF value of the glass filter medium layer 3 formed of the fibrous material including the glass fibers can be 10 or more.

The glass filter medium layer 3 of FIG. 1 is a single layer. The glass filter medium layer 3 may be a laminate composed of two or more identical or different layers.

In the air filter medium 1 of FIG. 1, an upstream surface 12 of the glass filter medium layer 3 forms one exposed surface of the filter medium 1. The exposed surface is the surface through which the airflow 11 flows into the filter medium 1. An additional layer may be placed on the upstream side in the direction of the airflow 11 with respect to the glass filter medium layer 3.

In the air filter medium 1 of FIG. 1, the glass filter medium layer 3 and the porous fluorine resin membrane 2 are in contact with each other. An additional layer may be placed between the glass filter medium layer 3 and the porous fluorine resin membrane 2. The glass filter medium layer 3 suppresses the generation of static electricity during the manufacturing and use of the air filter medium 1, compared with the use of a prefilter formed of a nonwoven fabric formed of a resin fiber. Accordingly, even when the glass filter medium layer 3 and the porous fluorine resin membrane 2 are in contact with each other, it is possible to suppress damage to the porous fluorine resin membrane 2 due to static electricity.

The air filter medium of the present invention may include an additional layer and/or member as long as the effects of the present invention can be achieved.

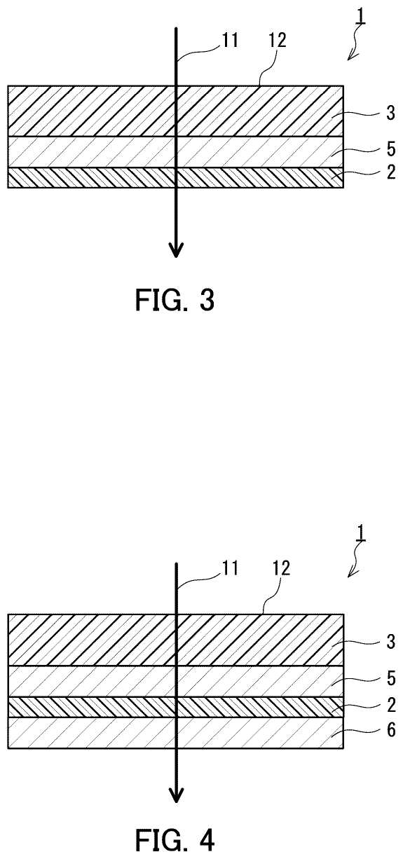

FIG. 3 shows an example of the air filter medium 1 including an additional layer. The air filter medium 1 of FIG. 3 further includes a first air-permeable supporting layer 5. The first air-permeable supporting layer 5 is placed between the glass filter medium layer 3 and the porous fluorine resin membrane 2. In the air filter medium 1 of FIG. 3, the glass filter medium layer 3, the first air-permeable supporting layer 5, and the porous fluorine resin membrane 2 are placed in this order from upstream to downstream of the air filter medium 1 configured to allow the airflow 11 to pass through the air filter medium 1. In other words, the glass filter medium layer 3 and the first air-permeable supporting layer 5 are placed in this order from upstream on the upstream side in the direction of the airflow 11 with respect to the porous fluorine resin membrane 2. The air filter medium 1 of FIG. 3 includes one glass filter medium layer 3, one first air-permeable supporting layer 5, and one porous fluorine resin membrane 2.

### (First Air-Permeable Supporting Layer)

The first air-permeable supporting layer 5 can function as a layer that supports the porous fluorine resin membrane 2 from the upstream side in the direction of the airflow 11. The first air-permeable supporting layer 5 can also function as a layer that hinders the movement of liquid particles once collected by the glass filter medium layer 3 to the porous fluorine resin membrane 2.

The first air-permeable supporting layer 5 is formed of, for example, a fibrous material. The average fiber diameter of the fibrous material that can form the first air-permeable supporting layer 5 may be greater than the average fiber diameter of the fibrous material that can form the glass filter medium layer 3. In other words, the first air-permeable supporting layer 5 serving as a prefilter that collects a portion of the collection object contained in the airflow 11 may have lower performance than the glass filter medium layer 3.

The average fiber diameter of the fibrous material that can form the first air-permeable supporting layer 5 may be more than 5 μm, 8 μm or more, 12 μm or more, 16 μm or more, or even 18 μm or more. The upper limit of the average fiber diameter is, for example, 50 μm or less and may be 40 μm or less, 30 μm or less, or even 27 μm or less.

The fibrous material that can form the first air-permeable supporting layer 5 includes, for example, at least one fiber selected from a glass fiber, a resin fiber, and a metal fiber. Examples of the resin fiber include polyolefin fibers, such as a polyethylene (PE) fiber and a polypropylene (PP) fiber, polyester fibers, such as a polyethylene terephthalate (PET) fiber and a polyethylene naphthalate fiber, acrylic fibers, such as an acrylonitrile fiber, and polyamide fibers, such as an aromatic polyamide fiber. The resin fiber may be a composite fiber of two or more resins. An example of the composite fiber is a fiber having a core-sheath structure composed of a core and a sheath covering the core. The melting point of the sheath may be lower than the melting point of the core. A specific example of the composite fiber is a fiber composed of a PET core and a PE sheath. In this case, since PE strongly joins to the porous fluorine resin membrane 2, the first air-permeable supporting layer 5 and the porous fluorine resin membrane 2 are more reliably joined together. The first air-permeable supporting layer 5 may be a nonwoven fabric formed of a resin fiber. An example of the nonwoven fabric is a spunbond nonwoven fabric.

The first air-permeable supporting layer 5 may include a material other than those described above. An example of the material is a binder for binding the fibers in the first air-permeable supporting layer 5 formed of the fibrous material. Examples of the binder are the same as the examples of the binder that can be included in the glass filter medium layer 3.

The thickness of the first air-permeable supporting layer 5 is, for example, 100 to 550 μm and may be 150 to 450 μm or even 200 to 350 μm.

The grammage (weight per unit area) of the first air-permeable supporting layer 5 is, for example, 10 g/m² or more and may be 15 g/m² or more, 20 g/m² or more, or even 30 g/m² or more. The upper limit of the grammage is, for example, 100 g/m² or less and may be 70 g/m² or less.

The first air-permeable supporting layer 5 is generally a layer that has higher air permeability in the thickness direction than the porous fluorine resin membrane 2 and the glass filter medium layer 3. The initial pressure drop PD₀ of the first air-permeable supporting layer 5 at a permeate flow rate of 5.3 cm/s is, for example, 1 to 60 Pa and may be 2 to 20 Pa, 2 to 10 Pa, or even 2 to 4 Pa.

The collection efficiency CE of the first air-permeable supporting layer 5 as measured at a permeate flow rate of 5.3 cm/s using monodisperse PAO particles is, for example, 20% or less and may be 10% or less. The lower limit of the collection efficiency CE is, for example, 1% or more and may be 5% or more.

The first air-permeable supporting layer 5 of FIG. 3 is a single layer. The first air-permeable supporting layer 5 may be a laminate composed of two or more identical or different layers.

The first air-permeable supporting layer 5 of FIG. 3 is in contact with the glass filter medium layer 3 and the porous fluorine resin membrane 2. An additional layer may be placed between the first air-permeable supporting layer 5 and the glass filter medium layer 3. An additional layer may be placed between the first air-permeable supporting layer 5 and the porous fluorine resin membrane 2.

In the air filter medium 1 of FIG. 3, one outermost layer is the glass filter medium layer 3, while the other outermost layer is the porous fluorine resin membrane 2.

FIG. 4 shows another example of the air filter medium 1 including an additional layer. The air filter medium 1 of FIG. 4 has the same configuration as the configuration of the air filter medium 1 of FIG. 4, except for the further inclusion of a second air-permeable supporting layer 6. The second air-permeable supporting layer 6 is placed on the downstream side in the direction of the airflow 11 with respect to the porous fluorine resin membrane 2. The second air-permeable supporting layer 6, together with the first air-permeable supporting layer 5, sandwiches the porous fluorine resin membrane 2. The air filter medium 1 of FIG. 4 includes one glass filter medium layer 3, one first air-permeable supporting layer 5, one porous fluorine resin membrane 2, and one second air-permeable supporting layer 6.

### (Second Air-Permeable Supporting Layer)

The second air-permeable supporting layer 6 can function as a layer that supports the porous fluorine resin membrane 2 from the downstream side in the direction of the airflow 11. The second air-permeable supporting layer 6 is generally a layer that has higher air permeability in the thickness direction than the porous fluorine resin membrane 2 and the glass filter medium layer 3.

The second air-permeable supporting layer 6 is formed of, for example, a fibrous material. However, the second air-permeable supporting layer 6 is not limited to a layer formed of a fibrous material as long as the second air-permeable supporting layer 6 can support the porous fluorine resin membrane 2.

The second air-permeable supporting layer 6 can have any combination of the configurations and/or the properties described above for the first air-permeable supporting layer 5. The second air-permeable supporting layer 6 may be identical to the first air-permeable supporting layer 5.

The second air-permeable supporting layer 6 of FIG. 4 is in contact with the porous fluorine resin membrane 2. An additional layer may be placed between the second air-permeable supporting layer 6 and the porous fluorine resin membrane 2. However, when the second air-permeable supporting layer 6 and the porous fluorine resin membrane 2 are in contact with each other with no additional layer therebetween, the initial pressure drop PD₀ of the air filter medium 1 can be further reduced.

In the air filter medium 1 of FIG. 4, one outermost layer is the glass filter medium layer 3, while the other outermost layer is the second air-permeable supporting layer 6.

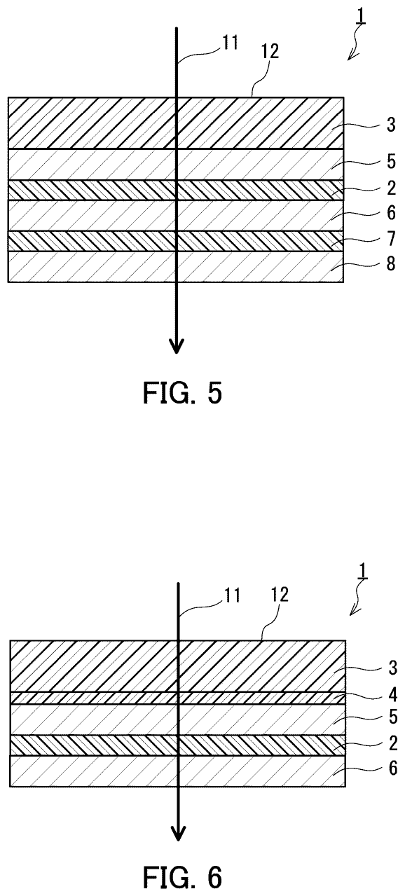

FIG. 5 shows yet another example of the air filter medium 1 including an additional layer. The air filter medium 1 of FIG. 5 has the same configuration as the configuration of the air filter medium 1 of FIG. 5, except for the further inclusion of a second porous fluorine resin membrane 7 and a third air-permeable supporting layer 8. The porous fluorine resin membrane 7 is placed on the downstream side in the direction of the airflow 11 with respect to the porous fluorine resin membrane 2 and the second air-permeable supporting layer 6. The third air-permeable supporting layer 8 is placed on the downstream side in the direction of the airflow 11 with respect to the porous fluorine resin membrane 7. The second air-permeable supporting layer 6 and the third air-permeable supporting layer 8 sandwich the porous fluorine resin membrane 7. The air filter medium 1 of FIG. 5 includes one glass filter medium layer 3, one first air-permeable supporting layer 5, one porous fluorine resin membrane 2, one second air-permeable supporting layer 6, one porous fluorine resin membrane 7, and one third air-permeable supporting layer 8.

### (Second Porous Fluorine Resin Membrane)

The second porous fluorine resin membrane 7, as well as the porous fluorine resin membrane 2, can function as a main filter of the air filter medium 1.

The porous fluorine resin membrane 7 can have any combination of the configurations and/or the properties described above for the porous fluorine resin membrane 2. The porous fluorine resin membrane 7 may be identical to the porous fluorine resin membrane 2. The porous fluorine resin membrane 7 may be a membrane that has lower air permeability (higher pressure drop PD) and/or higher collection efficiency CE than the porous fluorine resin membrane 2.

The porous fluorine resin membrane 7 of FIG. 5 is in contact with the second air-permeable supporting layer 6. An additional layer may be placed between the porous fluorine resin membrane 7 and the second air-permeable supporting layer 6. However, when the porous fluorine resin membrane 7 and the second air-permeable supporting layer 6 are in contact with each other with no additional layer therebetween, the initial pressure drop PD₀ of the air filter medium 1 can be further reduced.

### (Third Air-Permeable Supporting Layer)

The third air-permeable supporting layer 8 can function as a layer that supports the porous fluorine resin membrane 7 from the downstream side in the direction of the airflow 11. The third air-permeable supporting layer 8 can have any combination of the configurations and/or the properties described above for the first air-permeable supporting layer 5. The third air-permeable supporting layer 8 may be identical to the first air-permeable supporting layer 5 and/or the second air-permeable supporting layer 6.

The third air-permeable supporting layer 8 of FIG. 5 is in contact with the porous fluorine resin membrane 7. An additional layer may be placed between the third air-permeable supporting layer 8 and the porous fluorine resin membrane 7. However, when the third air-permeable supporting layer 8 and the porous fluorine resin membrane 7 are in contact with each other with no additional layer therebetween, the initial pressure drop PD₀ of the air filter medium 1 can be further reduced.

In the air filter medium 1 of FIG. 5, one outermost layer is the glass filter medium layer 3, while the other outermost layer is the third air-permeable supporting layer 8.

The layers in the air filter medium 1 are joined to each other. The glass filter medium layer 3, the porous fluorine resin membranes, and the air-permeable supporting layers can be joined, for example, by thermal lamination or lamination using an adhesive. Joining by thermal lamination can suppress an increase in pressure drop at a joining interface and accordingly is preferred. The air filter medium 1 can be produced, for example, by joining the layers included in the filter medium 1.

As shown in FIG. 6, the porous fluorine resin membrane 2 or a laminate including the porous fluorine resin membrane 2 may be joined to the glass filter medium layer 3 by an air-permeable adhesive layer 4. In this case, the air filter medium 1 can be produced by joining the porous fluorine resin membrane 2 or the laminate including the porous fluorine resin membrane 2 to the glass filter medium layer 3 by the air-permeable adhesive layer 4. However, the production method for the air filter medium 1 is not limited to the above examples.

### (Embodiment Including Air-Permeable Adhesive Layer)

The air filter medium 1 of FIG. 6 has the same configuration as the configuration of the air filter medium 1 of FIG. 4, except for the further inclusion of the air-permeable adhesive layer 4 between the glass filter medium layer 3 and the porous fluorine resin membrane 2, more specifically, between the glass filter medium layer 3 and the first air-permeable supporting layer 5. In the air filter medium 1 of FIG. 6, the glass filter medium layer 3, the air-permeable adhesive layer 4, the first air-permeable supporting layer 5, the porous fluorine resin membrane 2, and the second air-permeable supporting layer 6 are placed in this order from upstream to downstream of the air filter medium 1 configured to allow the airflow 11 to pass through the air filter medium 1. In other words, the glass filter medium layer 3 and the air-permeable adhesive layer 4 are placed in this order from upstream on the upstream side in the direction of the airflow 11 with respect to the porous fluorine resin membrane 2.

The air-permeable adhesive layer 4 is a layer formed of an adhesive. The air-permeable adhesive layer 4 can function as a layer that joins the glass filter medium layer 3 and a laminate including the porous fluorine resin membrane 2. The air-permeable adhesive layer 4 can also function as a layer that hinders the movement of liquid particles once collected by the glass filter medium layer 3 to the porous fluorine resin membrane 2.

The grammage (weight per unit area) of the air-permeable adhesive layer 4 is, for example, 2 to 30 g/m². The lower limit of the grammage may be 4 g/m² or more, 5.5 g/m² or more, 6 g/m² or more, 7 g/m² or more, or even 8 g/m² or more. The upper limit of the grammage may be 25 g/m² or less, 24 g/m² or less, 20 g/m² or less, 18 g/m² or less, or even 16 g/m² or less.

Examples of the adhesive forming the air-permeable adhesive layer 4 include various adhesives such as rubber, acrylic, silicone, and urethane adhesives. The adhesive may be a hot-melt adhesive. More specific examples of the adhesive include a styrene-butadiene-styrene elastomer (SBS), a styrene-isoprene-styrene elastomer (SIS), an ethylene vinyl acetate (EVA), a polyolefin, and a polyamide. The adhesive is not limited to the above examples.

The air-permeable adhesive layer 4 may be a layer formed of a fibrous adhesive. The fibrous adhesive may be randomly dispersed in the in-plane direction and the thickness direction of the layer. The average fiber diameter of the fibrous adhesive is, for example, 10 to 30 μm and may be 15 to 28 μm or even 20 to 25 μm. The air-permeable adhesive layer 4 formed of the fibrous adhesive can be formed, for example, by spraying the adhesive on a layer to be in contact with the air-permeable adhesive layer 4 in the air filter medium 1. The air-permeable adhesive layer 4 formed of the fibrous adhesive formed on a transfer film by spraying or the like may be transferred to the layer to be in contact with the air-permeable adhesive layer 4.

The thickness of the air-permeable adhesive layer 4 is, for example, 5.5 to 16 μm and may be 6 to 14 μm or even 7 to 12 μm.

The air-permeable adhesive layer 4 of FIG. 6 is a single layer. The air-permeable adhesive layer 4 may be a laminate composed of two or more identical or different layers.

The air-permeable adhesive layer 4 of FIG. 6 is in contact with the glass filter medium layer 3 and the first air-permeable supporting layer 5. An additional layer may be placed between the air-permeable adhesive layer 4 and the glass filter medium layer 3. An additional layer may be placed between the air-permeable adhesive layer 4 and the first air-permeable supporting layer 5.

The thickness of the air filter medium 1 is, for example, 200 to 1000 μm and may be 300 to 900 μm or even 400 to 800 μm.

The grammage (weight per unit area) of the air filter medium 1 is, for example, 60 to 200 g/m² and may be 80 to 180 g/m² or even 100 to 160 g/m².

The initial pressure drop PD₀ of the air filter medium 1 at a permeate flow rate of 5.3 cm/s is, for example, 50 to 300 Pa and may be 70 to 250 Pa or even 100 to 200 Pa. The air filter medium 1 generally has lower initial pressure drop PD₀ than a glass fiber filter medium having the same collection efficiency CE.

The collection efficiency CE of the air filter medium 1 as measured at a permeate flow rate of 5.3 cm/s using monodisperse PAO particles is, for example, 85% or more and may be 90% or more, 95% or more, 97% or more, 98% or more, or even 99% or more. The upper limit of the collection efficiency CE is, for example, 99.99% or less and may be 99.9% or less.

The PF value determined for the air filter medium 1 by the above equation (4) is, for example, 15 or more and may be 16 or more. The upper limit of the PF value is, for example, 30 or less and may be 35 or less or even 32 or less.

When the change in the pressure drop of the air filter medium 1 is measured by allowing polydisperse PAO particles to pass through the air filter medium 1 at a concentration of 0.2 to 0.5 g/m³ and a linear velocity of 5.3 cm/s, the amount of polydisperse PAO particles collected by the air filter medium 1 when the pressure drop reaches 500 Pa (hereinafter referred to as “PAO retention amount”) is, for example, 50 g/m² or more and may be 60 g/m² or more, 70 g/m² or more, 80 g/m² or more, 90 g/m² or more, or even 95 g/m² or more. The upper limit of the PAO retention amount is, for example, 200 g/m² or less. A larger PAO retention amount increases the extent to which the above increase in pressure drop is suppressed, for example, enabling the air filter medium 1 to have an extended service life when used in an environment containing fine particles having a particle size of approximately 0.1 μm.

Since the air filter medium 1 suppresses an increase in pressure drop while suppressing a reduction in collection efficiency even in an environment containing fine particles having a particle size of approximately 0.1 μm, the air filter medium 1 is suitable for filter applications in outside air filtration, such as turbine air-intake filters and outside air introduction filters. However, the applications of the air filter medium 1 are not limited to the above examples. The air filter medium 1 can be used in the same application as conventional air filter media.

The air filter medium 1 can be distributed, for example, in a sheet shape or a strip shape. The strip-shaped air filter medium 1 can be distributed in the form of a wound body wound around a winding core.

The air filter medium 1 can be used as, for example, a pleated filter pleat pack.

### [Filter Pleat Pack]

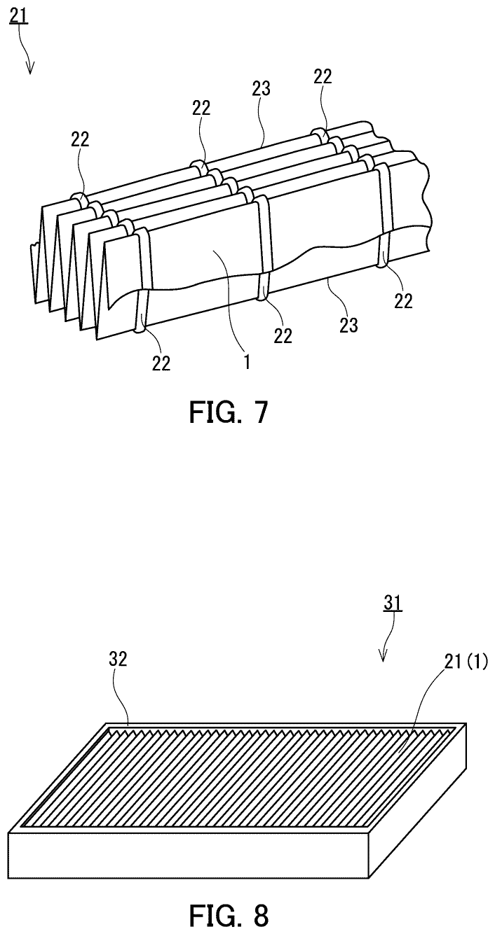

FIG. 7 shows an example of the filter pleat pack of the present embodiment. A filter pleat pack 21 shown in FIG. 7 includes the air filter medium 1 folded into pleats. The filter pleat pack 21 is formed by pleating the air filter medium 1. The air filter medium 1 is folded to have a continuous W-shape when viewed laterally. By forming the air filter medium 1 into the pleat pack 21, an air filter unit incorporating the air filter medium 1 can have an increased filtration area relative to its ventilation area (opening area of the frame). Owing to the inclusion of the air filter medium 1, the filter pleat pack 21 is suitable for use in an environment containing fine particles having a particle size of approximately 0.1 μm.

The filter pleat pack of the present invention may include an additional member other than the air filter medium 1. The filter pleat pack 21 shown in FIG. 7 further includes a string-shaped resin referred to as a bead 22. The bead 22 is a type of spacer that maintains the shape of the pleated air filter medium 1. In FIG. 7, the bead 22 is placed on the surface of the folded air filter medium 1 to extend along a direction intersecting with a pleat line 23 (mountain fold line and/or valley fold line) of the air filter medium 1. However, the shape and arrangement of the bead 22 are not limited to the above example. In FIG. 7, the bead 22 is placed on both surfaces of the air filter medium 1; alternatively, the bead 22 may be placed on only one surface of the air filter medium 1. It is preferred to place the bead 22 not on the porous fluorine resin membrane 2 but on the glass filter medium layer 3 and/or the air-permeable supporting layer 6, 8. The filter pleat pack 21 may include a plurality of the beads 22. When the placement surface for the bead 22 is viewed in plan, the plurality of beads 22 are arranged in parallel to each other at given intervals in the direction in which the pleat line 23 extends. In the example of FIG. 7, at least three beads 22 are placed on each placement surface. The bead 22 can be formed by applying a molten resin in a string shape. Examples of the resin include polyamides and polyolefins.

Pleating of the air filter medium 1 can be performed by a known technique, such as a technique using a reciprocating processing machine or a rotary processing machine.

### [Air Filter Unit]

FIG. 8 shows an example of the air filter unit of the present embodiment. An air filter unit 31 shown in FIG. 8 includes the filter pleat pack 21 and a frame 32 that supports the filter pleat pack 21. In the air filter unit 31, a peripheral portion of the filter pleat pack 21 is supported by the frame (support frame) 32. The frame 32 is formed of, for example, a metal, a resin, or a composite material thereof. When the frame 32 is formed of a resin, the filter pleat pack 21 can be fixed to the frame 32 simultaneously with the formation of the frame 32. The configuration of the frame 32 may be the same as the configuration of a frame included in a conventional air filter unit. Owing to the inclusion of the air filter medium 1, the air filter unit 31 is suitable for suppressing an increase in pressure drop while suppressing a reduction in collection efficiency, even in an environment containing fine particles having a particle size of approximately 0.1 μm.

The air filter unit 31 of FIG. 8 includes the air filter medium 1 as the filter pleat pack 21. The configuration of the air filter unit of the present invention is not limited to the above example as long as the air filter unit includes the air filter medium 1.

The air filter unit 31 may be a unit including a high-efficiency particulate air grade (HEPA) filter or an ultra-low penetration air grade (ULPA) filter as specified in JIS Z 8122:2000.

### EXAMPLES

The present invention is described below in more detail by way of examples. The present invention is not limited to the following examples.

First, the evaluation methods for the air filter media fabricated in the present examples and the layers included in the filter media are described.

### [Area S95 of Node]

The area S95 of the node in the porous fluorine resin membrane was evaluated by the above-described method.

### [Diameter D50 of Inscribed Circle]

The diameter D50 of the inscribed circle inscribed in the node-free region, that is, the distance between nodes, was evaluated by the above-described method.

### [Initial Pressure Drop PD₀]

The initial pressure drop PD₀ was evaluated by the above-described method.

### [Collection Efficiency CE]

The collection efficiency CE was evaluated by the above-described method. The monodisperse PAO particles used were prepared by generating particles from PAO (Durasyn 164) manufactured by INEOS using a constant-output aerosol atomizer (TSI No. 3076, manufactured by TSI Incorporated), classifying the particles into 0.1 μm using an electrostatic classifier (manufactured by TSI Incorporated), and neutralizing the particle charge using americium-241 (²⁴¹Am). The monodisperse PAO particles introduced into the air passing through the evaluation objects were single-peak particles having a number peak at a particle size of 0.1 μm.

### [PAO Retention Amount]

The PAO retention amount was evaluated by the above-described method. The polydisperse PAO particles used in the evaluation were generated from PAO (Durasyn 164) manufactured by INEOS using a constant-output aerosol atomizer (TSI No. 3076, manufactured by TSI Incorporated). The polydisperse PAO particles introduced into the air passing through the evaluation objects were particles having a number peak in the particle size range of 0.1 to 0.2 μm.

### [Fabrication of Porous PTFE Membrane A1]

An amount of 100 parts by weight of a PTFE fine powder (CD129E, manufactured by AGC Inc.) and 20 parts by weight of dodecane serving as a liquid lubricant were uniformly mixed to obtain a mixture. Next, the mixture was extruded into a sheet shape using an extruder to obtain a strip-shaped PTFE sheet (thickness of 1.5 mm, width of 20 cm). Then, the obtained PTFE sheet was rolled using a pair of metal pressure rolls. During the rolling, the PTFE sheet was pulled in the machine direction using another roll placed downstream of the pressure rolls so that the width of the PTFE sheet would be the same before and after the rolling. The rolled PTFE sheet had a thickness of 200 μm.

Next, the PTFE sheet was held in an atmosphere at 150° C. to remove the liquid lubricant. After that, the PTFE sheet was stretched by roll stretching in the machine direction at a stretching temperature T_{MD} of 300° C. and a stretch ratio R_{MD} of 13.5, and then stretched by tenter stretching in the transverse direction at a stretching temperature T_{TD} of 240° C. and a stretch ratio R_{TD} of 21. Thus, an unsintered porous PTFE membrane was obtained. The strain rate SR_{TD} in the transverse direction was 80%/s. Then, the obtained porous membrane was sintered at 500° C. in a hot-air furnace to obtain a strip-shaped porous PTFE membrane A1.

### [Fabrication of Porous PTFE Membrane A2]

A strip-shaped porous PTFE membrane A2 was obtained in the same manner as the porous PTFE membrane A1, except that during roll stretching, stretching was performed in the transverse direction at a stretching temperature T_{TD} of 190° C.

### [Fabrication of Porous PTFE Membrane A3]

A strip-shaped porous PTFE membrane A3 was obtained in the same manner as the porous PTFE membrane A1, except that during roll stretching, stretching was performed in the transverse direction at a stretching temperature T_{TD} of 130° C.

### [Fabrication of Porous PTFE Membrane A4]

A strip-shaped porous PTFE membrane A4 was obtained in the same manner as the porous PTFE membrane A1, except that during roll stretching, stretching was performed in the transverse direction at a stretching temperature T_{TD} of 100° C.

### [Fabrication of Porous PTFE Membrane A5]

An amount of 100 parts by weight of a PTFE fine powder (CD129E, manufactured by AGC Inc.) and 20 parts by weight of dodecane serving as a liquid lubricant were uniformly mixed to obtain a mixture. Next, the mixture was extruded into a sheet shape using an extruder to obtain a strip-shaped PTFE sheet (thickness of 1.5 mm, width of 20 cm). Then, the obtained PTFE sheet was rolled using a pair of metal pressure rolls. During the rolling, the PTFE sheet was pulled in the machine direction using another roll placed downstream of the pressure rolls so that the width of the PTFE sheet would be the same before and after the rolling. The rolled PTFE sheet had a thickness of 200 μm.

Next, the PTFE sheet was held in an atmosphere at 150° C. to remove the liquid lubricant. After that, the PTFE sheet was stretched by roll stretching in the machine direction at a stretching temperature T_{MD} of 300° C. and a stretch ratio R_{MD} of 19, and then stretched by tenter stretching in the transverse direction at a stretching temperature T_{TD} of 130° C. and a stretch ratio R_{TD} of 38. Thus, an unsintered porous PTFE membrane was obtained. The strain rate SR_{TD} in the transverse direction was 170%/s. Then, the obtained porous membrane was sintered at 500° C. in a hot-air furnace to obtain a strip-shaped porous PTFE membrane A5.

### [Fabrication of Porous PTFE Membrane A6]

A strip-shaped porous PTFE membrane A6 was obtained in the same manner as the porous PTFE membrane A5, except that the rolled PTFE sheet had a thickness of 400 μm; during roll stretching, stretching was performed in the machine direction at a stretching temperature T_{MD} of 300° C. and a stretch ratio R_{MD} of 20, and then stretching was performed by tenter stretching in the transverse direction at a stretching temperature T_{TD} of 140° C. and a stretch ratio R_{TD} of 45; and the strain rate SR_{TD} in the transverse direction was 160%/s.

### [Preparation of Glass Filter Medium Layer B]

As a glass filter medium layer B, a glass nonwoven fabric (H750-A, manufactured by Hokuetsu Corporation) having a thickness of 0.38 μm and a grammage of 63 g/m² was used.

### Example 1

The porous PTFE membrane A1 and the glass filter medium layer B were joined to each other by an air-permeable adhesive layer to obtain the air filter medium of Example 1. The joining was performed as follows: a hot-melt synthetic rubber adhesive (MORESCO-MELT TN-286Z, manufactured by MORESCO Corporation) was spray-coated onto one surface of the porous PTFE membrane A1 at a grammage of 8 g/m², and the glass filter medium layer B was press-laminated onto the sprayed surface. The press lamination was performed using a pair of rolls (The same applies to the subsequent examples and comparative examples).

### Example 2

The air filter medium of Example 2 was obtained in the same manner as in Example 1, except that the porous PTFE membrane A2 was used instead of the porous PTFE membrane A1.

### Example 3

The air filter medium of Example 3 was obtained in the same manner as in Example 1, except that the porous PTFE membrane A3 was used instead of the porous PTFE membrane A1.

### Example 4

The air filter medium of Example 4 was obtained in the same manner as in Example 1, except that the porous PTFE membrane A4 was used instead of the porous PTFE membrane A1.

### Comparative Example 1

The air filter medium of Comparative Example 1 was obtained in the same manner as in Example 1, except that the porous PTFE membrane A5 was used instead of the porous PTFE membrane A1.

### Comparative Example 2

The air filter medium of Comparative Example 2 was obtained in the same manner as in Example 1, except that the porous PTFE membrane A6 was used instead of the porous PTFE membrane A1.

Table 1 below shows the evaluation results for the porous PTFE membranes A1 to A6 included in the air filter media of the examples and comparative examples. Table 2 below shows the evaluation results for the glass filter medium layer B included in the air filter media of the examples and comparative examples. Table 3 below shows the evaluation results for the air filter media of the examples and comparative examples. The sign “-” in Table 3 indicates ‘not measured’.

TABLE 1

| | | | | | | Comparative | Comparative |
|---|---|---|---|---|---|---|---|
| | | Example 1 | Example 2 | Example 3 | Example 4 | Example 1 | Example 2 |
| Porous PTFE membrane | | A1 | A2 | A3 | A4 | A5 | A6 |
| Membrane | Area S95 of node [μm²] | 5.8 | 5.6 | 5.6 | 4.1 | 8.8 | 1.9 |
| structure | Diameter D50 of | 8.2 | 7.0 | 5.8 | 5.2 | 5.7 | 5.0 |
| | inscribed circle [μm] | | | | | | |
| Properties | PAO retention amount | 13.9 | 11.5 | 7.5 | 6.6 | 15.4 | 3.7 |
| | [g/m²] | | | | | | |
| | Pressure drop PD₀ [Pa] | 58 | 60 | 78 | 88 | 46 | 68 |
| | Collection efficiency | 96.72 | 97.83 | 99.41 | 99.63 | 94.73 | 99.31 |
| | CE [%] | | | | | | |
| Dried raw sheet | Thickness [μm] | 200 | 200 | 200 | 200 | 200 | 400 |
| (after rolling) | | | | | | | |
| MD stretching | Stretch ratio R_{MD} [times] | 13.5 | 13.5 | 13.5 | 13.5 | 19 | 20 |
| | Stretching | 300 | 300 | 300 | 300 | 300 | 300 |
| | temperature T_{MD} [° C.] | | | | | | |
| TD stretching | Stretch ratio R_{TD} [times] | 21 | 21 | 21 | 21 | 38 | 45 |
| | Stretching | 240 | 190 | 130 | 100 | 130 | 140 |
| | temperature T_{TD} [° C.] | | | | | | |
| | Strain rate SR_{TD} [%/s] | 80 | 80 | 80 | 80 | 170 | 160 |
| | Heat-setting | 500 | 500 | 500 | 500 | 500 | 500 |
| | temperature [° C.] | | | | | | |

| | | | | | | |
|---|---|---|---|---|---|---|
| Area magnification R_{MD} · R_{TD} [times] | 284 | 284 | 284 | 284 | 722 | 900 |
| R_{TD}/R_{MD} ratio | 1.56 | 1.56 | 1.56 | 1.56 | 2.00 | 2.25 |

TABLE 2

| Glass nonwoven fabric | | B |
|---|---|---|
| Properties | PAO retention amount [g/m²] | 130.8 |
| | Pressure drop PD₀ [Pa] | 56.5 |
| | Collection efficiency CE [%] | 74.33 |

TABLE 3

| | | | | | | Comparative | Comparative |
|---|---|---|---|---|---|---|---|
| | | Example 1 | Example 2 | Example 3 | Example 4 | Example 1 | Example 2 |
| Properties | PAO retention | — | 102 | 95 | — | — | 87 |
| | amount [g/m²] | | | | | | |
| | Pressure drop | — | 113 | 132 | — | — | 156 |
| | PD₀ [Pa] | | | | | | |
| | Collection | — | 99.51 | 99.81 | — | — | 99.77 |
| | efficiency CE [%] | | | | | | |
| | Atmospheric | — | >30 days | >30 days | — | — | 15 days |
| | dust test *a) | | | | | | |

*a) Number of days from initial pressure drop until pressure drop reaches 2000 Pa

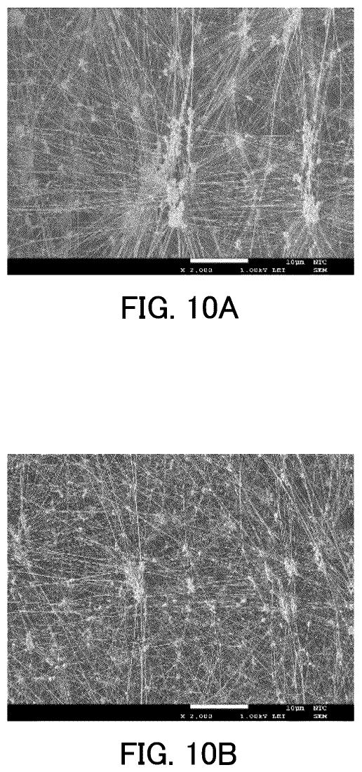

FIGS. 9A to 9D respectively show SEM images of the porous PTFE membranes A1 to A4 used in the air filter media of Examples 1 to 4. FIGS. 10A to 10B respectively show SEM images of the porous PTFE membranes A5 to A6 used in the air filter media of Comparative Examples 1 to 2. The magnification of the SEM images of FIGS. 9A to 10B is 2000 times.

FIG. 11A shows, as an example of the evaluations of the area S95 of the node and the diameter D50 of the inscribed circle, a node-only image obtained through fibril removal processing on a binarized image obtained from the SEM image of the porous PTFE membrane of Example 2 (FIG. 9B). FIG. 11B shows an image in which inscribed circles were identified from the node-only image of Example 2 (FIG. 11A).

FIG. 12A is a frequency distribution chart of the areas of the nodes in the porous PTFE membrane of Example 2, obtained based on the node-only image of Example 2 (FIG. 11A). FIG. 12B is a cumulative relative frequency distribution chart of the areas of the nodes in the porous PTFE membrane of Example 2, obtained based on the node-only image of Example 2 (FIG. 11A). From the cumulative relative frequency distribution chart of FIG. 12B, it is determined that the area S95 of the node in the porous PTFE membrane A2 used in Example 2 was 5.6 μm².

FIG. 13A is a frequency distribution chart of the diameters of the inscribed circles in the porous PTFE membrane of Example 2, obtained based on the image in which the inscribed circles were identified in Example 2 (FIG. 11B). FIG. 13B is a cumulative relative frequency distribution chart of the diameters of the inscribed circles in the porous PTFE membrane of Example 2, obtained based on the image in which the inscribed circles were identified in Example 2 (FIG. 11B). From the cumulative relative frequency distribution chart of FIG. 13B, it is determined that the diameter D50 of the inscribed circle, that is, the distance between nodes, in the porous PTFE membrane A2 used in Example 2 was 7.0 μm.

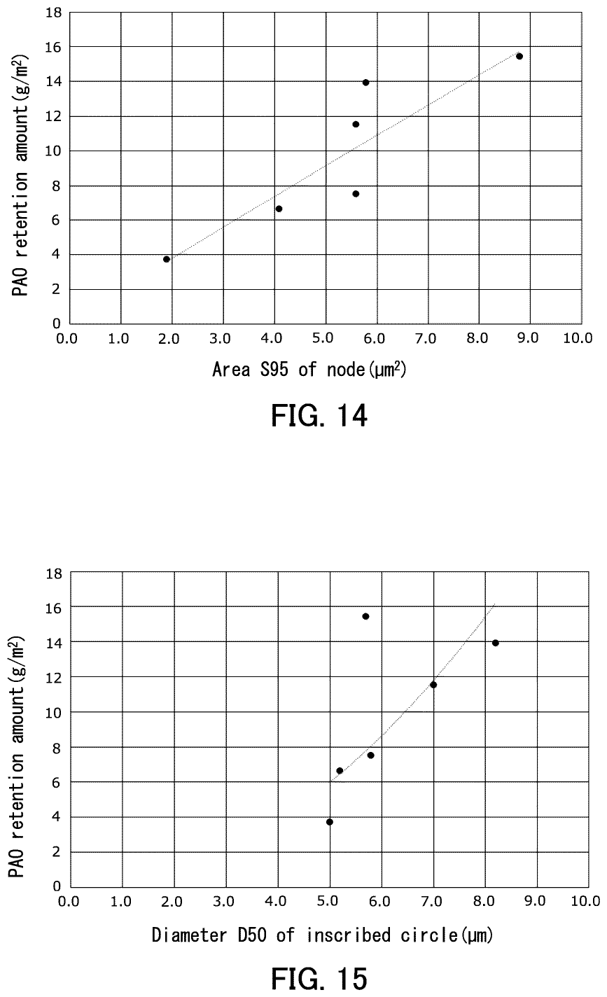

FIG. 14 shows the relationship between the area S95 of the node and the PAO retention amount in the porous PTFE membranes A1 to A6 used in the air filter media of Examples 1 to 4 and Comparative Examples 1 to 2. As is evident from FIG. 14, a tendency was observed for the PAO retention amount to generally increase as the area S95 of the node increases.

FIG. 15 shows the relationship between the diameter D50 of the inscribed circle and the PAO retention amount in the porous PTFE membranes A1 to A6 used in the air filter media of Examples 1 to 4 and Comparative Examples 1 to 2. As is evident from FIG. 15, a tendency was observed for the PAO retention amount to generally increase as the diameter D50 of the inscribed circle, that is, the distance between nodes, increases.

Although not shown in the figures, as understood from Table 1, Examples 1 to 4 exhibited a tendency such that, as the stretching temperature T_{TD} in the transverse direction decreases, the area S95 of the node and the diameter D50 of the inscribed circle (distance between nodes) decrease; and as the stretching temperature T_{T}m in the transverse direction decreases, the pressure drop PD₀ and the collection efficiency CE increase.

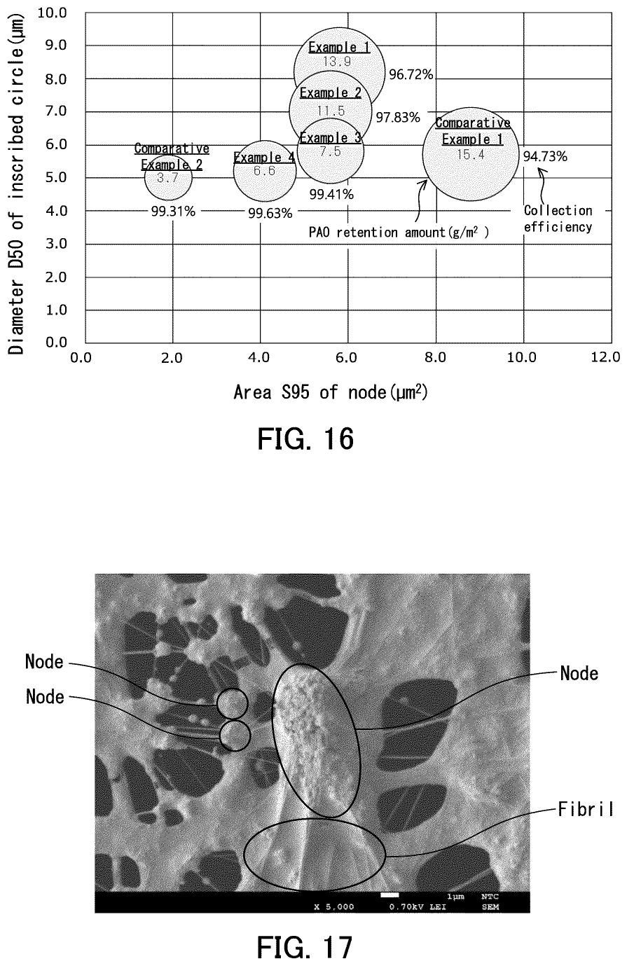

FIG. 16 shows the relationship between the area S95 of the node and the diameter D50 of the inscribed circle in the porous PTFE membranes used in the air filter media of Examples 1 to 4 and Comparative Examples 1 to 2, together with the PAO retention amount and the collection efficiency. As is evident from FIG. 16, in the porous PTFE membrane A5, which had the area S95 of the node exceeding 8.0 μm², used in the air filter medium of Comparative Example 1, the collection efficiency decreased while the PAO retention amount increased. This is presumably due to the fact that the remaining 5% of the nodes present in the porous PTFE membrane A5 were excessively large in size, reducing the collection efficiency locally in that portion, thereby resulting in a reduction in the overall collection efficiency of the porous PTFE membrane A5. Furthermore, in the porous PTFE membrane A6, which had the area S95 of the node smaller than 2.0 μm², used in the air filter medium of Comparative Example 2, the PAO retention amount significantly decreased and the pressure drop increased. This is presumably due to the fact that the remaining 5% of the nodes present in the porous PTFE membrane A6 were excessively small in size, further reducing the amount of fine particles collected in that portion, thereby resulting in a reduction in the total amount of fine particles collected by the porous PTFE membrane A6 and thus an increase in the pressure drop.

As shown in Table 1, the porous PTFE membranes A1 to A4 used in the air filter media of Examples 1 to 4 satisfied all of a pressure drop of 100 Pa or less, a collection efficiency of 95.0% or more, and a PAO retention amount of 6.0 g/m² or more, and the increase in pressure drop was suppressed while the reduction in collection efficiency was suppressed compared with the porous PTFE membranes A5 to A6 used in the air filter media of Comparative Examples 1 to 2. Furthermore, as shown in Table 3, in the air filter media of Examples 2 and 3, the increase in pressure drop was suppressed while the reduction in collection efficiency was suppressed compared with the air filter medium of Comparative Example 2. From these results, it is considered that the air filter media of Examples 1 to 4 are filter media suitable for suppressing an increase in pressure drop while suppressing a reduction in collection efficiency.

### INDUSTRIAL APPLICABILITY

The air filter medium of the present invention can be used in the same applications as conventional air filter media. Examples of the applications include air filter media, filter pleat packs, and air filter units used in outside air treatment filters and turbine air-intake filters.

1. An air filter medium comprising a porous fluorine resin membrane, the air filter medium further comprising a glass filter medium layer, wherein
the glass filter medium layer and the porous fluorine resin membrane are placed in this order from upstream to downstream of the air filter medium configured to allow airflow to pass through the air filter medium,
the porous fluorine resin membrane includes a plurality of nodes and a plurality of fibrils, and in an area distribution of the nodes, when an area of the node corresponding to a cumulative relative frequency of 95% from a smaller area is defined as S95, the porous fluorine resin membrane satisfies 2.0 m²≤S95≤8.0 m².

2. The air filter medium according to claim 1, wherein
in a diameter distribution of inscribed circles that are inscribed in a region free of the nodes, when a diameter of the inscribed circle corresponding to a cumulative relative frequency of 50% from a smaller diameter is defined as D50, the porous fluorine resin membrane satisfies D50>5.0 μm.

3. The air filter medium according to claim 1, wherein
the porous fluorine resin membrane has an initial pressure drop of 100 Pa or less when air is allowed to pass through the porous fluorine resin membrane at a linear velocity of 5.3 cm/s.

4. The air filter medium according to claim 1, wherein
the porous fluorine resin membrane has a collection efficiency of 95.0% or more as measured at a permeate flow rate of 5.3 cm/s using polyalphaolefin particles that are monodisperse particles having a number peak at a particle size of 0.1 m.

5. The air filter medium according to claim 1, wherein
when a change in pressure drop of the porous fluorine resin membrane is measured by allowing polyalphaolefin particles that are polydisperse particles having a number peak in a particle size range of 0.1 to 0.2 m to pass through the porous fluorine resin membrane at a concentration of 0.2 to 0.5 g/m³ and a linear velocity of 5.3 cm/s, an amount of the polyalphaolefin particles collected by the porous fluorine resin membrane when the pressure drop reaches 500 Pa is 6.0 g/m² or more.

6. The air filter medium according to claim 1, further comprising a first air-permeable supporting layer placed between the glass filter medium layer and the porous fluorine resin membrane.

7. The air filter medium according to claim 6, further comprising a second air-permeable supporting layer placed on a downstream side in a direction of the airflow with respect to the porous fluorine resin membrane.

8. The air filter medium according to claim 1, wherein
the porous fluorine resin membrane is a porous polytetrafluoroethylene membrane.

9. The air filter medium according to claim 1, comprising the one porous fluorine resin membrane.

10. A filter pleat pack comprising an air filter medium folded into pleats, wherein
the air filter medium is the air filter medium according to claim 1.

11. An air filter unit comprising an air filter medium, wherein
the air filter medium is the air filter medium according to claim 1.

12. An air filter unit comprising a filter pleat pack, wherein
the filter pleat pack is the filter pleat pack according to claim 10.
